(19) United States
(12) Patent Application Publication
(10) Pub. No.: US 2014/0338293 A1
(43) Pub. Date: Nov. 20, 2014

(54) Self-Cleaning Duplex Filter

(71) Applicant: The Hilliard Corporation, Elmira, NY (US)

(72) Inventors: Jon Williams, Horseheads, NY (US); Michael Long, Horseheads, NY (US)

(21) Appl. No.: 13/917,885

(22) Filed: Jun. 14, 2013

Related U.S. Application Data
(60) Provisional application No. 61/824,467, filed on May 17, 2013.

(51) Int. Cl. B01D 35/12; B01D 46/00; B01D 29/52

(52) U.S. Cl. CPC B01D 35/12; B01D 29/52; B01D 46/0067
USPC 55/283; 210/437; 210/323.1; 210/108; 210/341; 210/497.01; 210/493.5; 210/411; 55/495; 55/482; 55/288; 55/490; 55/492

(57) ABSTRACT

A duplex fluid filter assembly allows extended life between filter replacements, by automatically back-flushing one filter unit with clean fluid from another filter unit of the duplex assembly.

### CROSS REFERENCE TO RELATED APPLICATION

This application claims benefit of U.S. Provisional Application No. 61/824,467 filed May 17, 2013 for “Self-cleaning duplex filter”, the disclose of which is incorporated herein by reference in its entirety.

### BACKGROUND OF THE INVENTION

Aspects of the present disclosure are in the technical field of fluid filtration, including both liquid filtration and filtration of air and other gases.

In-line filtration to remove solid contaminants from circulating or flowing fluids, for example, from lubricants, coolants, and fuels is well known. However, it is generally necessary to interrupt the flow of fluid through a filter unit from time to time to replace the filter medium as it becomes clogged with solids. It has been proposed to provide a filter assembly including two filter units connected in parallel, so that one filter unit can remain in operation while the filter medium in the other is being replaced. However, replacing the filter medium is a messy and labor-intensive process. It is therefore desirable to increase the interval between filter replacements.

### SUMMARY OF THE INVENTION

The present disclosure teaches apparatus, methods, and programs for fluid filtration in which it is possible to filter a working fluid continuously for long periods without human intervention, by automatically back-flushing a filter unit without interrupting filtering of the working fluid.

Embodiments of the present invention provide filter units, filter systems, methods of operating such filter units and filter systems, and computer programs (which may be stored on a non-transitory tangible storage medium) for causing a processor controlling such a unit or system to carry out such a method.

One embodiment of the invention provides a filter unit comprising: a housing; a horizontal tube plate within the housing, separating the housing into upper and lower portions; at least one port in the tube plate, with a respective at least one connector for a respective at least one filter cartridge to be mounted in the housing upper portion; a fluid outlet below the tube plate and mounted within the housing lower portion, the at least one port communicating with the fluid outlet; a fluid inlet into the housing upper portion; at least one passage between the housing upper portion and the housing lower portion; and a drain communicating with the housing lower portion.

The at least one port in the tube plate may comprise a plurality of ports, and the fluid outlet may then comprise a manifold communicating with the plurality of ports.

The at least one passage may comprise one or more slots between an outer edge of the tube plate and a wall of the housing.

The fluid inlet may be positioned to cause incoming fluid to flow across an upper surface of the tube plate.

The filter unit may further comprise a respective at least one filter cartridge mounted on the at least one connector with an interior communicating through the at least one port with the fluid outlet.

Valves may be operative to selectively open and close the fluid inlet, the fluid outlet, and the drain.

An embodiment of the invention provides a method, and a controller and computer program operative to implement the method, to control the valves to place the filter unit in a selected one of a filtering mode in which at least one fluid inlet valve and at least one fluid outlet valve are open and a drain valve is closed, a back-flushing mode in which the fluid inlet valve is closed and at least one fluid outlet valve and the drain valve are open, and an offline mode in which at least one fluid inlet valve or fluid outlet valve is closed and the drain valve is closed.

A sensor may detect clogging of the at least one filter cartridge and switch the filter unit from the filtering mode to the back-flushing mode when a level of clogging exceeds a predetermined threshold. The sensor may then provide an input to the controller in response to which the controller switches the valves. The sensor may detect a pressure drop across the filter unit.

An embodiment of the invention provides a filter assembly comprising two filter units, each as mentioned above, having a common inlet and a common outlet, at least one inlet valve operative to selectively connect or disconnect the fluid inlet of each filter unit and the common inlet, at least one outlet valve to selectively connect or disconnect the fluid outlet of each filter unit and the common outlet, and drain valves to selectively open and close the drain of each filter unit.

The method, computer program, and/or controller may then control the valves to place each filter unit in a selected one of a filtering mode in which the fluid inlet valve and the fluid outlet valve are open for that filter unit and the drain valve is closed for that filter unit, a back-flushing mode in which the fluid inlet valve is closed, the fluid outlet valve or another fluid valve connecting an outlet side of the filter medium with the fluid outlet is open, and the drain valve is open for that filter unit, and an offline mode in which at least one of the fluid inlet valve and the fluid outlet valve is closed and the drain valve is closed for that filter unit.

The valves may be controlled: to place one filter unit in the filtering mode and the other filter unit in the offline mode; when clogging of the one filter unit is detected, to place the other filter unit in the filtering mode and the one filter unit in the back-flushing mode; and after back-flushing, to place the one filter unit in the offline mode and maintain the other filter unit in the filtering mode.

An embodiment provides a fluid system comprising: a path or circuit in which fluid flows or circulates; and a filter unit as mentioned above connected in the circuit so that in operation fluid enters the filter unit at the fluid inlet and leaves the filter unit at the fluid outlet.

An embodiment provides a filter assembly comprising two filter units, each comprising: a housing; a fluid inlet port into the housing; at least one connector for a respective at least one filter cartridge to be mounted in the housing; a fluid outlet port communicating with the at least one connector so as to be in communication with an interior of a filter cartridge mounted on the at least one connector; and a drain in a lower portion of the housing; the assembly further comprising: a common inlet; at least one inlet valve operative to selectively connect or disconnect the fluid inlet port of each filter unit and the common inlet; a common outlet; at least one outlet valve to selectively connect or disconnect the fluid outlet of each filter unit and the common outlet; drain valves to selectively open and close the drain of each filter unit; and a controller operative to control the valves to place each filter unit in a selected one of a filtering mode in which the fluid inlet valve and the fluid outlet valve are open and the drain valve is closed, a back-flushing mode in which the fluid inlet valve is closed, the fluid outlet valve or another fluid valve connecting an outlet side of the filter medium with the fluid outlet is open, and the drain valve is open, and an offline mode in which at least one of the fluid inlet valve and the fluid outlet valve is closed and the drain valve is closed.

The valves may be controlled: to place one filter unit in the filtering mode and the other filter unit in the offline mode; when clogging of the one filter unit is detected, to place the other filter unit in the filtering mode and the one filter unit in the back-flushing mode; and after back-flushing, to place the one filter unit in the offline mode and maintain the other filter unit in the filtering mode.

An embodiment of the invention provides a filter cartridge comprising a filter medium forming a tube and one or more shrunk-on, fitted, or clamped-on bands encircling the tube and restraining the tube against outward pressure.

The filter medium may be pleated, with inner edges of the pleats being supported by a perforated tube, and the pleats being in compression between the one or more bands and the tube. The filter medium may be stainless steel. The bands may be heat-shrink fluoropolymer.

The mentioned filter units and filter systems may be equipped with the mentioned filter cartridges.

### BRIEF DESCRIPTION OF THE DRAWINGS

The above and other aspects, features, and advantages of the present invention may be more apparent from the following more particular description of embodiments thereof, presented in conjunction with the following drawings. In the drawings:

FIG. 1 is a front elevation view, partly cut away, of one embodiment of a filter assembly.

FIG. 2 is a schematic diagram of the filter assembly shown in FIG. 1.

FIG. 3 is a perspective view of a filter cartridge suitable for use in the filter assembly of FIG. 1.

FIG. 4 is a cross-section through the filter cartridge of FIG. 3.

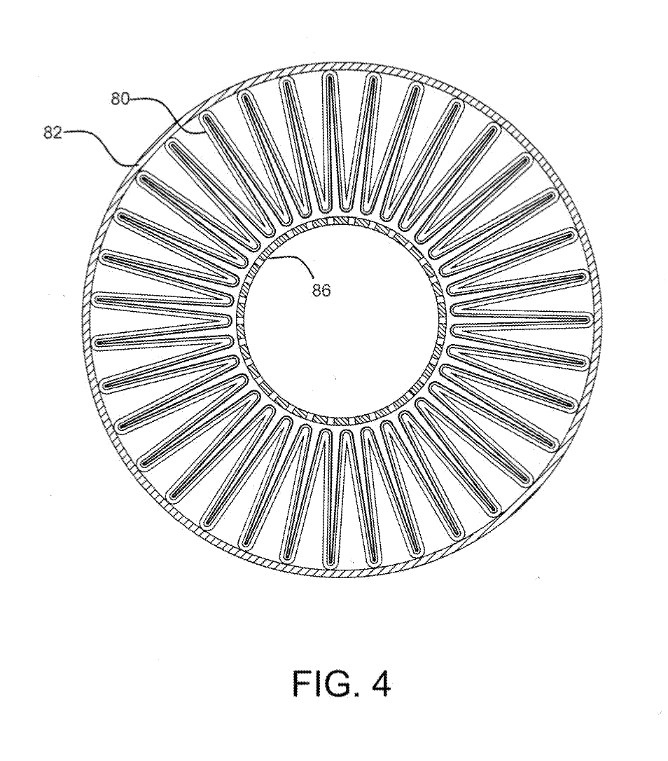

### DETAILED DESCRIPTION OF THE INVENTION

A better understanding of various features and advantages of the present methods and devices may be obtained by reference to the following detailed description of illustrative embodiments of the invention and accompanying drawings. Although these drawings depict embodiments of the contemplated methods and devices, they should not be construed as foreclosing alternative or equivalent embodiments apparent to those of ordinary skill in the subject art.

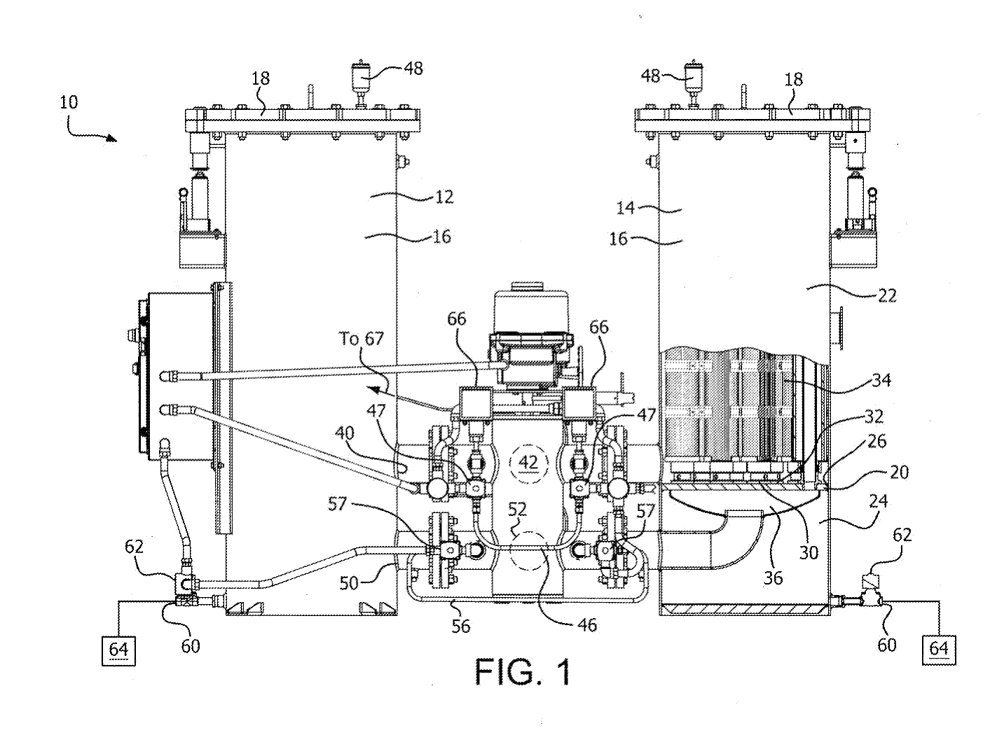

Referring to FIG. 1 of the accompanying drawings, one form of filter assembly 10 comprises two filter units 12, 14. Each filter unit 12, 14 comprises an upright cylindrical housing 16 with a removable lid 18. A horizontal tube plate 20 is mounted across the housing 16, dividing the interior of the housing 16 into a larger upper portion 22 and a smaller lower portion 24. Housing lower portion 24 is larger than is conventional, in this embodiment approximately 25% of the volume of housing upper portion 22. The upper and lower housing portions 22, 24 are in communication via slots 26 between the tube plate 20 and the wall of the housing 16. The slots 26 extend round most of the circumference of the tube plate 20, separated by relatively short bridges by which the tube plate 20 is joined to the housing 16. Air vent valves 48 are provided in the top of the housings 16.

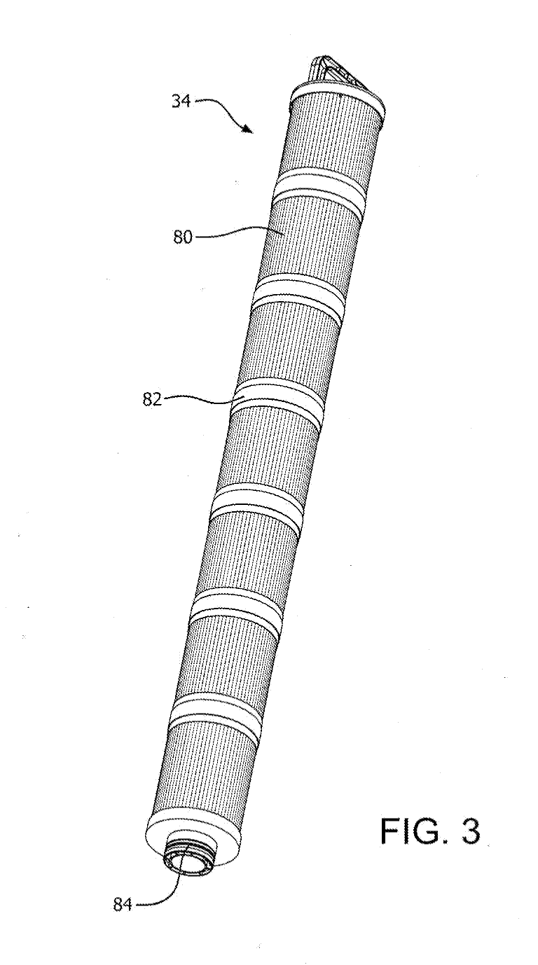

The tube plate 20 is provided with an array of ports 30 with connectors 32 on the upper side of the tube plate 20 for connecting to one or more filter cartridges 34. The filter cartridges 34 may be of conventional design, and include a tubular filter surface, a closed upper end, and an open lower end (or an opening in the lower end) with a fitting that mates with the connectors 32 so as to provide a conduit from the inside of each filter cartridge to a port 30. An O-ring seal 84 (see FIG. 3) is preferred between cartridges 34 and port connectors 32, because conventional flat gasket seals tend to leak under reverse pressure. However, the O-ring seal itself may be conventional.

Referring to FIG. 3, in an embodiment, the filter medium of each filter cartridge 34 is a pleated stainless steel screen 80, supported on the inside by a perforated metal tube 86. On the outside, the pleats are encircled by bands 82, preferably made from heat-shrunk tubing of fluorinated ethylene propylene (FEP) or other suitable fluoropolymer. The bands 82 are dimensioned so that, if unconstrained, they would shrink to approximately 60% of the external diameter of cartridge 34. As a result, the bands 82 are in tension, and the pleats of screen 80 are placed under radial compression. As explained below, such a construction will restrain the pleated screen against outward pressure. The bands 82 are, therefore, considerably stronger than the cloth bands that are used on conventional pleated filter cartridges, which merely serve to stabilize the pleats against lateral movement. While the bands are preferably made from shrunk tubing, it is also contemplated that they could be clamped or crimped on or fitted onto the cartridges. The thickness of the stainless steel screen material is chosen to resist the compression force.

On the underside of the tube plate 20, the ports 30 open into a manifold 36 that isolates the ports 30 from the lower housing portion 24. Thus, fluid flow into the housing upper portion 22 passes through the filter surfaces of the filter cartridges 34 into the interior of the cartridge and through the ports into the manifold 36.

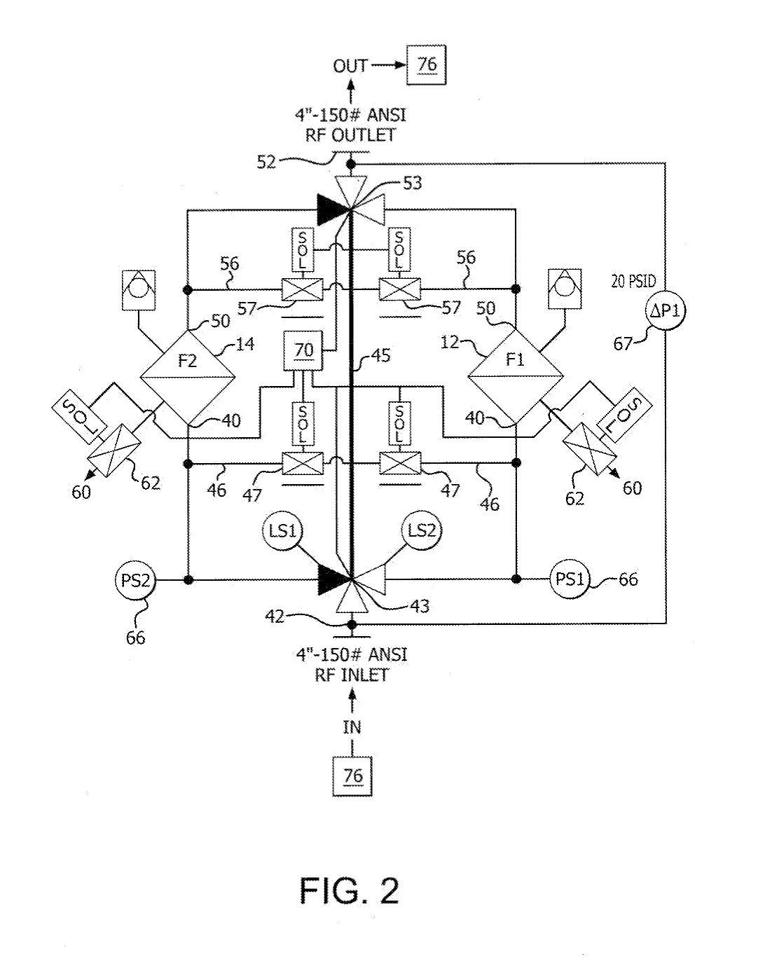

Each filter unit 12, 14 has an inlet port 40, positioned in a side of the housing 16, with the bottom of the inlet port 40 preferably level with the upper face of the tube plate 20. In operation, the position of the inlet port 40 causes a fluid current across the top of the tube plate 20 which tends to sweep any solids that may have settled on the tube plate 20 across to the slots 26, allowing the solids to fall into the housing lower portion 24 or be directed through the filter media. The filter assembly 10 has a common inlet 42, which is in communication with the inlet ports 40 of both filter units 12, 14 through a two position three-way valve 43 (see FIG. 2) that acts as a transfer valve, directing incoming fluid to one or other of the filter units 12, 14. The inlet ports 40 are connected by a cross-pipe 46 with a pair of solenoid-controlled valve 47. Two oppositely facing solenoid-controlled valves 47 are provided to close the cross-pipe 46 against pressure differentials in both directions. Alternatively, a single valve of a type that seals against pressure differentials in both directions, such as a ball valve, may be used.

Each filter unit 12, 14 has an outlet port 50, positioned in a side of the housing 16 below the tube plate 20, and communicating with the manifold 36. The filter assembly 10 has a common outlet 52, which is in communication with the outlet ports 50 of both filter units 12, 14 through a two-position three-way valve 53 (see FIG. 2) that acts as a transfer valve, connecting one or other of the filter units 12, 14 to the outlet 52. Three way valve 53 is ganged to three way valve 43 by a common shaft 45, so that they operate together. The outlet ports 50 are connected by a cross-pipe 56 with a pair of solenoid-controlled valves 57, similarly to valves 47. In use, the common inlet 42 and the common outlet 52 are connected to an external fluid system 76 in which a fluid that requires filtering flows or circulates, so that the fluid enters the filter assembly 10 at the common inlet 42 and leaves the filter assembly 10 at the common outlet 52.

Each filter unit 12, 14 has a drain 60, at the bottom of the housing lower portion 24, which is controlled by a normally-closed solenoid-operated drain valve 62. The drains 60 are connected to a recovery unit 64 that extracts fluid and solids from the housing lower portion 24 and allows the solids to be removed for disposal or further processing.

Pressure sensors 66 are provided on the inlet side of each filter unit 12, 14. At least one differential pressure sensor 67 is provided to measure the pressure difference between the common fluid inlet 42 and the common fluid outlet 52.

A controller unit 70 receives inputs from the pressure sensors 66, 67 and operates the valves 43, 44, 53, 54, 62 as described below. The controller unit 70 may be a programmable logic controller, a general purpose computer suitably programmed, or other suitable device having non-volatile storage for instructions, volatile or non-volatile storage for data indicating the configuration and current state of the filter assembly 10, and a processor, logic circuitry, or other mechanism for executing the instructions in accordance with input data so as to operate the valves.

In normal operation, one of the filter units, for example, filter unit 12, is placed in a filtering mode and the other filter unit, in this example filter unit 14, is placed in an offline mode by controller 70 setting the inlet transfer valve 43 and the outlet transfer valve 53 to direct fluid from the inlet 42 to the outlet 52 through the one filter unit 12 and not through the other filter unit 14. The pressure equalization and backflush valves 47, 57 are all closed. The drain valves 62 are closed. The external circuit 76 operates, and fluid circulates through the active filtering unit 12. The fluid passes in through the inlet port 40 into the housing upper portion 16 flowing around the outside of the filter cartridge 34 (or cartridges if there are more than one). The fluid flow passes radially inward through the filter media and into the center of the filter cartridge and downward to the lower opening in the cartridge. The fluid flows through the connectors 32 and the ports 30 in the tube plate 20 to the manifold 36 where it collects and is channeled through the outlet 50.

The filter media of the filter cartridges 34 separates out solid contaminants from the fluid in the usual way. During filtration the contaminated (dirty) fluid flows from the inlet 40 around the outside of the cartridge(s) 34 and passes through the filter media. The filter media captures or separates the solid contaminants in the fluid flow. With a stainless steel screen filter medium 80, the solid contaminants are caught on the surface of the filter, rather than being embedded within its thickness. Some of the contaminants will fall from the filter medium and settle onto the tube plate 20 and, because of the flow of fluid from the inlet 40 across the tube plate 20, those solids will be washed across to the far edge of the tube plate 20, and fall through the slots 26, so as to settle in the housing lower portion 24. The large size of housing lower portion 24 provides both a region of almost stagnant fluid within which solids can settle out, and a space in which the solids can accumulate. Much of the solids, however, will become trapped in the filter media, gradually clogging the filter media thereby reducing its effectiveness and increasing the resistance to flow through the filter unit 12.

The pressure sensor 67 monitors the pressure drop across the filter cartridges 34, which is indicative of the degree of clogging of the filter medium, by comparing the pressures at ports 42 and 52. When the pressure drop exceeds a threshold, the controller unit 70 activates the back-flushing mode of the filter unit 12. The threshold may be close to the threshold at which, in a comparable conventional filter unit, the cartridges would have been removed for washing. It is desirable to carry out the back-flushing procedure before housing lower portion 24 fills up with solid contaminants. However, if housing lower portion 24 does fill up, loose contaminants will be trapped in housing upper portion 22, and will rapidly clog filter medium 80 and trigger a back-flush.

In order to back-flush the first filter unit 12, the controller 70 first checks the pressures in the housings 16 of the two filter units 14, using the additional pressure sensors 66, to ensure that they are approximately equal. If the pressures are not sufficiently nearly equal, they can be equalized by the controller 70 opening the inlet pressure equalization valves 47. That may be necessary, for example, to reduce the torque required to operate three-way valve 43. The second filter unit 14 is then placed in its filtering mode, by controller 70 changing over the transfer valves 43, 53, thereby ensuring that operation of the external circuit 76 is not interrupted, and isolating the first filter unit 12. The controller 70 then opens the two outlet back-flush valves 57, and opens the drain valve 62 of the first filter unit 12. If the external circuit 76 is pressurized, there is then a pressure difference from the common outlet 52 to the drain 60, which causes cleansed fluid to flow in the reverse direction through outlet 50 up through the ports and into the center of the cartridges 34 of the first filter unit 12. The flow then flows radially outwardly through the filter media of the filter cartridges 34, thereby dislodging the contaminants on the filter media. As explained above, the bands 82 restrain the pleated filter medium 80 against the back-pressure. In normal operation, the gauge pressure in the outlet 52 is typically sufficient to back-flush the filter media without additional assistance. The reverse flow back-flushes the filter cartridges 34, dislodging a large proportion of the trapped solids from the filter media. Since the inlet valve 42 of the first filter unit 12 is closed, after passing outward through the filter media, the fluid flows through the slots 26 and into the housing lower portion 24 with the solids. The dirty fluid flows out through the drain 60 carrying with it both the dislodged solids and the solids that have previously settled in the bottom of the housing lower portion 24. The rate of flow of the back-flushing fluid is limited by the size of the cross-pipes 56 and the outlet 60, and may be chosen to provide effective back-flushing without wasting too much fluid or starving the outlet side of the fluid system 76.

When back-flushing is completed, the controller 70 closes the drain valve 62 of the filter unit 12 that is being back-flushed, and closes the back-flush valves 57. Back-flushing may be continued for a predetermined time, or until a predetermined amount of fluid has been used. The filter unit 12 is then in the offline mode, and the other filter unit 14 remains in the filtering mode. Eventually, the filter unit 14 in turn needs back-flushing, and the back-flushing process is carried out for the filter unit 14, with the filter unit 12 becoming the unit in the filtering mode.

The process may be continued for a considerable time, with the two filter units alternating in the filtering and offline modes, until the filter medium of the cartridges 34 either deteriorates or becomes clogged with a proportion of the solids that cannot be dislodged by back-flushing. At that time, either filter unit 12, 14, or both in succession, may be renewed by isolating the relevant filter unit 12, 14 from the fluid circuit 76, removing the lid 18, and removing and replacing the filter cartridges 34. The used filter cartridges, depending on their type and condition, may be processed in any appropriate way. For example, they may be cleaned by a more powerful procedure such as high-pressure washing or steam cleaning and reused, or they may be refurbished, recycled or discarded.

In an example, 400 GPM (25 l/s) of hydrocarbon fuel at 65 psig (450 kPa), with a constant solids content, was passed through a test filter. In an embodiment, the filter housing 16 is approximately 20″ (500 mm) in diameter. There are six slots, each approximately 1″ (25 mm) wide and 9″ 225 mm) long, separated by lands 1½″ (40 to 50 mm) long. There are 15 filter cartridges, each 4¼″ (110 mm) in diameter. The cartridges are rated for a collapse strength of 150 psid in the forward (inward) direction, and a burst strength of 30 psid in the reverse (outward) direction. With a new filter, a clogging threshold of 15 to 20 psid (100 to 140 kPa) was reached in 90 to 100 minutes. It was found that back-flushing with 50 gallons (190 liters) of clean fuel (which takes about 5 minutes) every 15 to 20 minutes was sufficient to keep the pressure drop below the threshold, with no noticeable deterioration over at least 80 cycles. Thus, the time between filter changes can, be increased by at least a factor of 80.

As may be seen from the above description, the described filter apparatus makes possible efficient and economical filtration, because the back-flushing process can be entirely automatic, so that human intervention is required only when the filter cartridges need to be replaced, and the possibility of repeated back-flushing allows for a much longer interval between replacements than in a conventional system. Also, because the back-flushing is driven by the existing system pressure, the back-flushing process can be carried out simply by manipulating valves that must already be present. Thus, the only additional hardware required is to upgrade valves from manual to electrical operation, and an electronic controller that can be very simple.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

For example, the filter assembly 10 shown in the drawings has two filter units 12, 14. A filter assembly 10 having more than two filter units would also be possible. In that case, one or more filter units may be in each of the filtering, back-flushing, and offline modes, and/or two or more filter units may be in the same one of those modes, depending on the demands of the fluid system in which the filter assembly is installed.

While the connectors are described in the above embodiment as a separate component, it is also contemplated that the connectors can be formed as an extension of the filter cartridge that mates with the port 30, or an extension of the port 30 that mates with an opening in the cartridge.

Accordingly, reference should be made to the appended claims, rather than to the foregoing specification, as indicating the scope of the invention.

1. A filter unit comprising:
a housing;
a horizontal tube plate within the housing, separating the housing into upper and lower portions;
at least one port in the tube plate, with a respective at least one connector for a respective at least one filter cartridge to be mounted in the housing upper portion;
a fluid outlet below the tube plate and mounted within the housing lower portion, the at least one port communicating with the fluid outlet;
a fluid inlet into the housing upper portion;
at least one passage between the housing upper portion and the housing lower portion; and
a drain communicating with the housing lower portion.

2. The filter unit of claim 1, wherein the at least one port comprises a plurality of ports, and the fluid outlet comprises a manifold communicating with the plurality of ports.

3. The filter unit of claim 1, wherein the at least one passage comprises one or more slots between an outer edge of the tube plate and a wall of the housing.

4. The filter unit of claim 1, wherein the fluid inlet is positioned to cause incoming fluid to flow across an upper surface of the tube plate.

5. The filter unit of claim 1, further comprising a respective at least one filter cartridge mounted on the at least one connector with an interior communicating through the at least one port with the fluid outlet.

6. The filter unit of claim 1, further comprising valves operative to selectively open and close the fluid inlet, the fluid outlet, and the drain.

7. The filter unit of claim 6, further comprising a controller operative to control the valves to place the filter unit in a selected one of a filtering mode in which at least one fluid inlet valve and at least one fluid outlet valve are open and a drain valve is closed, a back-flushing mode in which the fluid inlet valve is closed and at least one fluid outlet valve and the drain valve are open, and an offline mode in which at least one fluid inlet valve or fluid outlet valve is closed and the drain valve is closed.

8. The filter unit of claim 7, further comprising a sensor to detect clogging of the at least one filter cartridge and to switch the filter unit from the filtering mode to the back-flushing mode when a level of clogging exceeds a predetermined threshold.

9. The filter unit of claim 8, wherein the sensor detects a pressure drop across the filter unit.

10. A filter assembly comprising two filter units, each according to claim 1, having a common inlet and a common outlet, at least one inlet valve operative to selectively connect or disconnect the fluid inlet of each filter unit and the common inlet, at least one outlet valve to selectively connect or disconnect the fluid outlet of each filter unit and the common outlet, and drain valves to selectively open and close the drain of each filter unit.

11. The filter assembly of claim 10, further comprising a controller operative to control the valves to place each filter unit in a selected one of a filtering mode in which the fluid inlet valve and the fluid outlet valve are open for that filter unit and the drain valve is closed for that filter unit, a back-flushing mode in which the fluid inlet valve is closed and at least one fluid outlet valve and the drain valve are open for that filter unit, and an offline mode in which at least one of the fluid inlet valve and the fluid outlet valve is closed and the drain valve is closed for that filter unit.

12. The filter assembly of claim 10, wherein the controller is operative to control the valves:
to place one filter unit in the filtering mode and the other filter unit in the offline mode;
when clogging of the one filter unit is detected, to place the other filter unit in the filtering mode and the one filter unit in the back-flushing mode; and
after back-flushing, to place the one filter unit in the offline mode and maintain the other filter unit in the filtering mode.

13. A fluid system comprising:
a path or circuit in which fluid flows or circulates; and
a filter unit according to claim 1 connected in the path or circuit so that in operation fluid enters the filter unit at the fluid inlet and leaves the filter unit at the fluid outlet.

14. A filter assembly comprising
two filter units, each comprising:
a housing;
a fluid inlet port into the housing;
at least one connector for a respective at east one filter cartridge to be mounted in the housing;
a fluid outlet port communicating with the at least one connector so as to be in communication with an interior of a filter cartridge mounted on the at least one connector; and
a drain in a lower portion of the housing;
the assembly further comprising:
a common inlet;
at least one inlet valve operative to selectively connect or disconnect the fluid inlet port of each filter unit and the common inlet;
a common outlet;
at least one outlet valve to selectively connect or disconnect the fluid outlet of each filter unit and the common outlet;
drain valves to selectively open and close the drain of each filter unit; and
a controller operative to control the valves to place each filter unit in a selected one of a filtering mode in which the fluid inlet valve and the fluid outlet valve are open and the drain valve is closed, a back-flushing mode in which the fluid inlet valve is closed and the drain valve and at least one valve connecting the fluid outlet port with the common outlet are open, and an offline mode in which at least one of the fluid inlet valve and the fluid outlet valve is closed and the drain valve is closed.

15. The filter assembly of claim 14, wherein the controller is operative to control the valves:
to place one filter unit in the filtering mode and the other filter unit in the offline mode;
when clogging of the one filter unit is detected, to place the other filter unit in the filtering mode and the one filter unit in the back-flushing mode; and
after back-flushing, to place the one filter unit in the offline mode and maintain the other filter unit in the filtering mode.

16. The filter assembly of claim 15, wherein each filter unit further comprises:
a horizontal tube plate within the housing, separating the housing into an upper portion and the lower portion;
the at least one connector being mounted in a port in the tube plate for the respective at least one filter cartridge to be mounted in the housing upper portion;
the fluid outlet below the tube plate;
the fluid inlet into the housing upper portion; and
at least one passage between the housing upper portion and the housing lower portion.

17. The filter assembly of claim 14, wherein the at least one connector in each filter unit comprises a plurality of connectors, and the fluid outlet port communicates with the plurality of connectors through a manifold.

18. The filter unit of claim 16, wherein the at least one passage comprises one or more slots between an outer edge of the tube plate and a wall of the housing.

19. The filter unit of claim 16, wherein the fluid inlet port is positioned to cause incoming fluid to flow across an upper surface of the tube plate.

20. The filter unit of claim 14, further comprising a respective at least one filter cartridge mounted on the at least one connector with an interior communicating with the fluid outlet port.

21. The filter unit of claim 14, further comprising a sensor to detect clogging of the at least one filter cartridge and to switch the respective filter unit from the filtering mode to the back-flushing mode and to switch the other of the two filter units from the offline mode to the filtering mode when a level of clogging exceeds a predetermined threshold.

22. The filter unit of claim 14, wherein the sensor detects a pressure drop across the filter unit.

23. A filter cartridge comprising a filter medium forming a tube and one or more shrunk-on bands encircling the tube and restraining the tube against outward pressure.

24. The filter cartridge of claim 23, wherein the bands are made from heat-shrink material.

25. The filter cartridge of claim 23, wherein the filter medium is pleated, inner edges of the pleats are supported by a perforated tube, and the pleats are in compression between the one or more bands and the tube.

26. The filter cartridge of claim 23, wherein the filter medium is stainless steel and the bands are fluoropolymer.
